(19) United States
(12) Patent Application Publication
(10) Pub. No.: US 2014/0340700 A1
(43) Pub. Date: Nov. 20, 2014

(54) IMAGE FORMING APPARATUS

(71) Applicant: KYOCERA Documents Solutions Inc., Osaka-shi, Osaka (JP)

(72) Inventors: Tsuyoshi Nitta, Osaka (JP); Masaki Baba, Osaka (JP)

(21) Appl. No.: 14/365,049

(22) PCT Filed: Dec. 19, 2012
(86) PCT No.: PCT/JP2012/082955

§ 371 Date: Jun. 12, 2014

(30) Foreign Application Priority Data
Dec. 21, 2011 (JP) 2011-279145

(51) Int. Cl. H04N 1/32

(52) U.S. Cl. CPC H04N 1/32363; H04N 1/32448; H04N 2201/0082; H04N 2201/3298
USPC 358/1.13

(57) ABSTRACT

The input image processing circuit 12 confirms whether the output side buffer area has a free area for buffering image data after the input side image processing or not when starting image scanning. If the output side buffer area has the free area, the input image processing circuit 12 transfers the image data after the input side image processing through the interface 31 to the output image processing circuit 23 and causes the output image processing circuit 23 to store the image data in the output side buffer area without buffering the image data in the input side buffer area. If the output side buffer area does not have the free area, the input image processing circuit 12 buffers the image data after the input side image processing in the input side buffer area.

### TECHNICAL FIELD

The present invention relates to an image forming apparatus.

### BACKGROUND ART

In an image forming apparatus, a transfer mode of image data from the image input side to the image output side is changed in accordance with a print setting (see PATENT LITERATURE #1, for example).

### CITATION LIST

### Patent literature

PATENT LITERATURE #1: Japanese patent application publication No. 2008-109291

### SUMMARY OF INVENTION

### Technical Problem

However, in the aforementioned image forming apparatus, the transfer mode of image data from the image input side to the image output is fixed during a copy job, and therefore, the transfer mode may not be optimal when the load status of its system is changed in an execution period of the copy job.

The present invention has been made in view of the aforementioned problem, and its object is to obtain an image forming apparatus that transfers image data from its image input side to its image output side in an optimal transfer mode according to the load status of its system in an execution period of a copy job.

### Solution to Problem

The present invention solves the aforementioned problem as follows.

An image forming apparatus according to the present invention includes an input image processing circuit that performs input side image processing for an image of image scanning; an image input side memory in which an input side buffer area is allocated by the input image processing circuit; an output image processing circuit that performs output side image processing for printing; an image output side memory in which an output side buffer area is allocated by the output image processing circuit; and an interface that connects the input image processing circuit and the output image processing circuit. The input image processing circuit confirms whether the output side buffer area has a free area for buffering image data after the input side image processing or not when starting image scanning. If the output side buffer area has the free area, the input image processing circuit transfers the image data after the input side image processing through the interface to the output image processing circuit and causes the output image processing circuit to store the image data in the output side buffer area without buffering the image data in the input side buffer area. If the output side buffer area does not have the free area, the input image processing circuit buffers the image data after the input side image processing in the input side buffer area.

### Advantageous Effect of Invention

On the basis of the present invention, it is possible to obtain an image forming apparatus that transfers image data from its image input side to its image output side in an optimal transfer mode according to the load status of its system in an execution period of a copy job.

These and other objects, features and advantages of the present invention will become more apparent upon reading of the following detailed description along with the accompanied drawings.

### BRIEF DESCRIPTION OF DRAWINGS

FIG. 1 shows a block diagram that indicates a configuration of an image forming apparatus according to an embodiment of the present invention; and

FIG. 2 shows a flowchart that explains a behavior of an input image processing circuit in FIG. 1.

### DESCRIPTION OF EMBODIMENTS

Hereinafter, an embodiment of the present invention will be explained with reference to drawings.

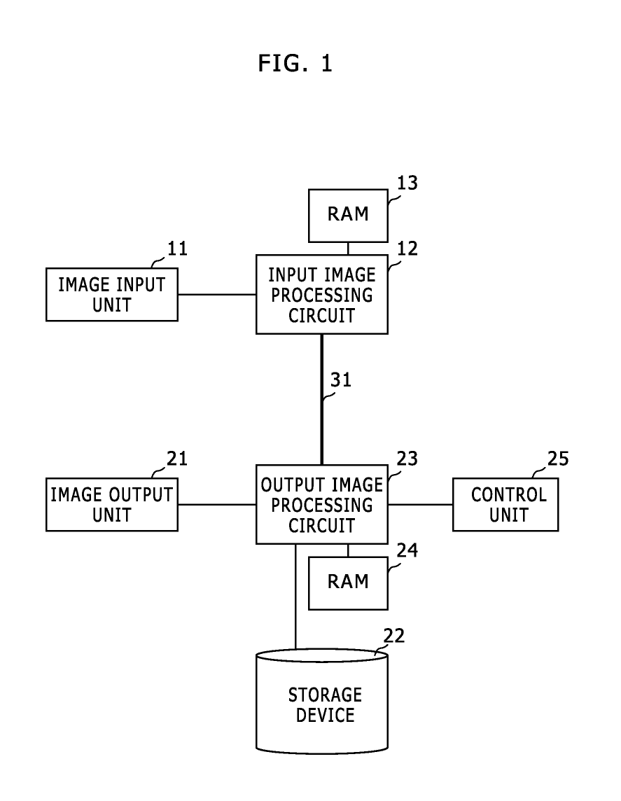

FIG. 1 shows a block diagram that indicates a configuration of an image forming apparatus according to an embodiment of the present invention. The image forming apparatus shown in FIG. 1 includes an image input unit 11, an input image processing circuit 12, and a RAM 13 in its image input side system, and includes an image output unit 21, a storage device 22, an output image processing unit 23, a RAM 24, and a control unit 25 in its image output side system. For example, the image input side system and the image output side system are configured on respective different circuit boards and connected by an interface 31.

In FIG. 1, the image input unit 11 is an internal device that feeds plural pages of a document in turn, for example, using an auto document feeder (ADF), optically scans images of the document page by page, and generates image data of each page image.

The input image processing circuit 12 performs input side image processing for an image of image scanning. The input side image processing includes resolution conversion, image data format conversion, color conversion, and the like. For example, the input image processing circuit 12 is configured with an ASIC (Application Specific Integrated Circuit) or the like.

When a copy job is started, the input image processing circuit 12 allocates an input side buffer area in the RAM 13. Subsequently, for every page of a document, the input image processing circuit 12 confirms whether an output side buffer area (mentioned below) has a free area for buffering image data of one page after the input side image processing or not. If the output side buffer area has a free area for buffering image data of one page after the input side image processing, the input image processing circuit 12 transfers the image data after the input side image processing through the interface 31 to the output image processing circuit 23 and causes the output image processing circuit 23 to store the image data in the output side buffer area without buffering the image data in the input side buffer area. If the output side buffer area does not have a free area for buffering image data of one page after the input side image processing, the input image processing circuit 12 buffers the image data after the input side image processing in the input side buffer area in the RAM 13.

The RAM (Random Access Memory) 13 is an image input side memory in which the input side buffer area is allocated by the input image processing circuit 12. The RAM 13 is directly connected to the input image processing circuit 12, and the input image processing circuit 12 reads and writes data from and to the RAM 13 using a built-in memory controller.

The image output unit 21 is an internal device that prints an image on a printing paper sheet page by page on the basis of image data from the output image processing circuit 23 using an electrophotographic method.

The storage device 22 is a non volatile large scale data storage device for storing image data after output side image processing by the output image processing circuit 23 in an image output side. As the storage device 22, a hard disc drive, an SSD (Solid State Drive), or the like is used.

The output image processing circuit 23 performs output side image processing for printing. The output side image processing includes resolution conversion, enlargement and reduction of an image, rotation of an image, and the like. For example, the output image processing circuit 23 is configured with an ASIC or the like. The output image processing circuit 23 (a) allocates an output side buffer area in the RAM 24 when a copy job is started, (b) stores image data in an output side buffer area in the RAM 24 when the image data is received through the interface 31 from the input image processing circuit 12, (c) performs the output side image processing for the image data stored in the output side buffer area using the output side buffer area and outputs the image data after output side image processing to the image output unit 21 and/or the storage device 22.

The RAM 24 is an image output side memory in which the output side buffer area is allocated by the output image processing circuit 23. The RAM 24 is directly connected to the output image processing circuit 23, and the output image processing circuit 23 reads and writes data from and to the RAM 24 using a built-in memory controller. In this embodiment, the output side buffer area has a size that is either equal to or larger than a size of image data of one page after the input side image processing. If the size of image data of one page after the input side image processing is not a constant, the output side buffer area has a size that is either equal to or larger than the largest size of image data of one page after the input side image processing.

Since the RAM 13 is located in the image input side, the RAM 13 is used only for a process for image data from the image input unit 11. On the other hand, the RAM 24 is used not only for processing image data from the image input side but for sorts of processes that include a process corresponding to a request from the control unit 25. Therefore, the RAM 24 is filled more easily than the RAM 13. Consequently, the output side buffer area is also filled more easily than the input side buffer area.

The control unit 25 is a computer configured with a CPU (Central Processing Unit), a ROM (Read Only Memory), a RAM and so forth, and receives a job such as a copy job and causes the output image processing circuit 23 or the like to perform an operation corresponding to the job.

The interface 31 connects the input image processing circuit 12 and the output image processing circuit 23. As the interface 31, for example, PCIe (Peripheral Components Interconnect express) is used.

In the following part, a behavior of the aforementioned image forming apparatus is explained. Here behaviors of the input image processing circuit 12 and the output image processing circuit 23 are explained.

### (1) A Behavior of the Input Image Processing Circuit 12

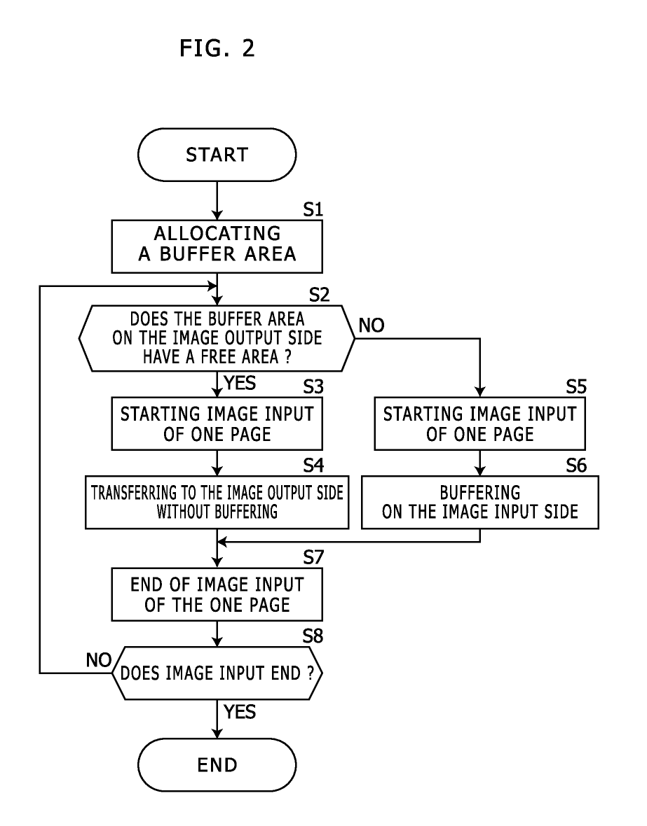

FIG. 2 shows a flowchart that explains a behavior of the input image processing circuit 12 in FIG. 1.

When a copy job is started, the input image processing circuit 12 allocates a predetermined size of an input side buffer area in the RAM 13 (in Step S1).

Subsequently, through the interface 31, the input image processing circuit 12 inquires of the output image processing circuit 23 whether or not the output side buffer area in the RAM 24 has a free area with a predetermined size (the largest size of image data of one page after the input side image processing) or more (in Step S2).

If the output side buffer area has such free area, the input image processing circuit 12 controls the image input unit 11 and causes the image input unit 11 to start image scanning of one page (in Step S3), and transfers image data obtained from the image input unit 11 to the output image processing circuit 23 through the interface 31 without buffering the image data in the input side buffer area in the RAM 13 (in Step S4).

Contrarily, if the output side buffer area does not have such free area, the input image processing circuit 12 controls the image input unit 11 and causes the image input unit 11 to start image scanning of one page (in Step S5), and buffers image data obtained from the image input unit 11 in the input side buffer area in the RAM 13 (in Step S6). Afterward, the input image processing circuit 12 repeatedly confirms whether the output side buffer area has a free area for buffering image data after the input side image processing or not, and when the output side buffer area has a free area for buffering image data after the input side image processing, the input image processing circuit 12 reads the image data after the input side image processing from the input side buffer area and transmits the read image data to the output image processing circuit 23 through the interface 31.

When the image scanning of one page is finished (in Step S7), the input image processing circuit 12 identifies whether a subsequent page exists in the copy job or not (in Step S8), and if the subsequent page exists, returning to Step S2, the subsequent page is processed in the same manner (in Steps S2 to S7).

Contrarily, if a subsequent page does not exist in the copy job, the input image processing circuit 12 terminates the image input of the copy job. After the image input of the copy job is finished, the input image processing circuit 12 may release the input side buffer area.

### (2) A Behavior of the Output Image Processing Circuit 23

When a copy job is started, the output image processing circuit 23 allocates a predetermined size of an output side buffer area in the RAM 24.

When image data is received from the input image processing circuit 12, the output image processing circuit 23 firstly stores the image data in the output side buffer area, and reads the image data from the output buffer area and performs the output side image processing for the read image data. For temporarily memorizing image data in the output side image processing, the output side buffer area is used. Subsequently, the output image processing circuit 23 outputs the image data after the output side image processing, and deletes the outputted image data and intermediate data of the output side image processing of the image data from the output side buffer area. Otherwise, the output image processing circuit 23 releases the memory area allocated in the output side buffer area for the outputted image data and intermediate data of the output side image processing of the image data.

Further, when the aforementioned inquiry on a free area in the output side buffer area is received from the input image processing circuit 12, the output image processing circuit 23 responds of whether the output side buffer area has the free area or not.

Furthermore, the output image processing circuit 23 outputs the image data after the output side image processing to the image output unit 21 and/or the storage device 22.

As mentioned, in the aforementioned embodiment, the input image processing circuit 12 confirms whether the output side buffer area has a free area for buffering image data after the input side image processing or not when starting image scanning. If the output side buffer area has such free area, the input image processing circuit 12 transfers the image data after the input side image processing through the interface 31 to the output image processing circuit 23 and causes the output image processing circuit 23 to store the image data in the output side buffer area in the RAM 24 without buffering the image data in the input side buffer area. If the output side buffer area does not have such free area, the input image processing circuit buffers the image data after the input side image processing in the input side buffer area in the RAM 13.

Therefore, even if a free area size in the output side buffer area fluctuates in accordance with the load status of the output image processing circuit 23 and so forth, a transfer mode is selected corresponding to the free area size in the output side buffer area. Consequently, image data is transferred from the image input side to the image output side in an optimal transfer mode according to the load status of its system in an execution period of a copy job.

Specifically, when the output side buffer area is filled due to a heavy load of the image output side system, the input side buffer area is used and image data is buffered in the input side buffer area until the free area is available in the output side buffer area. Contrarily, when the output side buffer area has the free area due to a light load of the image output side system, the image data is immediately transferred to the image output side.

Consequently, since the output buffer area is not in use in an early period of a copy job, the first copy is started in a short waiting time. Further, in the view of the whole copy job, a transfer rate of image data from the image input side to the image output side is high, and therefore, a 1 to 1 copy can be performed fast. Furthermore, since the input side buffer area is provided, even if the output buffer area is filled due to a heavy load of the image output side system, buffering in the input side buffer area enables to continually scan page images of a document without stopping continuous document feeding by an ADF and so forth in the middle. Likewise, when writing image data in the storage device 22 by the output image processing circuit 23 is delayed due to a noise or the like, even if the output buffer area is filled due to the delay, buffering in the input side buffer area enables to continually scan page images of a document without stopping continuous document feeding by an ADF and so forth in the middle.

It should be noted that the aforementioned description has been presented for purposes of illustration and description, and is not intended to be exhaustive nor to limit the present invention.

For example, the aforementioned embodiment may be configured so that if duplex printing is set in a copy job, for a page to be printed later in one of a front side and a back side, the input image processing circuit 12 buffers image data after the input side image processing in the input side buffer area, and for a page to be printed earlier in the other of the front side and the back side, the input image processing circuit 12 confirms whether the output side buffer area has a free area for buffering image data after the input side image processing or not, transfers the image data after the input side image processing through the interface 31 to the output image processing circuit 23 and causes the output image processing circuit 23 to store the image data in the output side buffer area without buffering the image data in the input side buffer area if the output side buffer area has the free area, and buffers the image data after the input side image processing in the input side buffer area if the output side buffer area does not have the free area.

Consequently, image data of a page to be printed earlier in the other of the front side and the back side in duplex printing is preferentially transferred from the image input side to the image output side.

Further, the aforementioned embodiment may be configured so that the aforementioned output side buffer area has a size that is either equal to or larger than a size of the image data after the input side image processing of document pages included in one printing page in case of combination printing. Consequently, since image data of the first printing page in combination printing (for example, in case of 4 in 1, image data of four pages of a document after the input side image processing) is always transferred from the image input side to the image output side without being buffered, printing the first page is started in a short waiting time.

Furthermore, the aforementioned embodiment may be configured so that the input image processing circuit 12 confirms whether the output side buffer area has a free area for buffering image data after the input side image processing or not when starting image scanning of the first page in a copy job, transfers the image data after the input side image processing through the interface 31 to the output image processing circuit 23 and causes the output image processing circuit 23 to store the image data in the output side buffer area without buffering the image data in the input side buffer area if the output side buffer area has the free area, and buffers the image data after the input side image processing in the input side buffer area if the output side buffer area does not have the free area, and for a page after the first page in the copy job, the input image processing circuit 12 buffers image data after the input side image processing in the input side buffer area immediately without confirmation of a free area in the output side buffer area.

Furthermore, the aforementioned embodiment may be configured so that the input side buffer area and the output side buffer area are allocated when this image forming apparatus starts (i.e. the image input side system and the image output side system start).

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

### INDUSTRIAL APPLICABILITY

For example, the present invention is applicable to an image forming apparatus such as a copier or a multi function peripheral.

1. An image forming apparatus, comprising:
an input image processing circuit that performs input side image processing for an image of image scanning;
an image input side memory in which an input side buffer area is allocated by the input image processing circuit;
an output image processing circuit that performs output side image processing for printing;
an image output side memory in which an output side buffer area is allocated by the output image processing circuit; and
an interface that connects the input image processing circuit and the output image processing circuit;
wherein the input image processing circuit confirms whether the output side buffer area has a free area for buffering image data after the input side image processing or not when starting image scanning, transfers the image data after the input side image processing through the interface to the output image processing circuit and causes the output image processing circuit to store the image data in the output side buffer area without buffering the image data in the input side buffer area if the output side buffer area has the free area, and buffers the image data after the input side image processing in the input side buffer area if the output side buffer area does not have the free area.

2. The image forming apparatus according to claim 1, wherein the input image processing circuit confirms for every page of a document whether the output side buffer area has a free area for buffering image data of one page after the input side image processing or not when starting image scanning of one page, transfers the image data after the input side image processing through the interface to the output image processing circuit and causes the output image processing circuit to store the image data in the output side buffer area without buffering the image data in the input side buffer area if the output side buffer area has the free area, and buffers the image data after the input side image processing in the input side buffer area if the output side buffer area does not have the free area.

3. The image forming apparatus according to claim 2, wherein in case of duplex printing, for a page to be printed later in one of a front side and a back side, the input image processing circuit buffers image data after the input side image processing in the input side buffer area, and for a page to be printed earlier in the other of the front side and the back side, the input image processing circuit confirms whether the output side buffer area has a free area for buffering image data after the input side image processing or not, transfers the image data after the input side image processing through the interface to the output image processing circuit and causes the output image processing circuit to store the image data in the output side buffer area without buffering the image data in the input side buffer area if the output side buffer area has the free area, and buffers the image data after the input side image processing in the input side buffer area if the output side buffer area does not have the free area.

4. The image forming apparatus according to claim 2, wherein the input image processing circuit confirms whether the output side buffer area has a free area for buffering image data after the input side image processing or not when starting image scanning of the first page, transfers the image data after the input side image processing through the interface to the output image processing circuit and causes the output image processing circuit to store the image data in the output side buffer area without buffering the image data in the input side buffer area if the output side buffer area has the free area, and buffers the image data after the input side image processing in the input side buffer area if the output side buffer area does not have the free area; and for a page after the first page, the input image processing circuit buffers image data after the input side image processing in the input side buffer area.

5. The image forming apparatus according to claim 1, wherein the output side buffer area has a size that is either equal to or larger than a size of the image data of one page after the input side image processing.

6. The image forming apparatus according to claim 1, wherein the output side buffer area has a size that is either equal to or larger than a size of the image data after the input side image processing of document pages included in one printing page in case of combination printing.

7. The image forming apparatus according to claim 1, wherein if the input image processing unit buffered the image data after the input side image processing in the input side buffer area, the input image processing circuit repeatedly confirms whether the output side buffer area has a free area for buffering image data after the input side image processing or not, and when the output side buffer area has the free area, the input image processing circuit reads the image data after the input side image processing from the input side buffer area and transmits the read image data to the output image processing circuit through the interface.
